(19) United States
(12) Patent Application Publication
(10) Pub. No.: US 2009/0289872 A1
(43) Pub. Date: Nov. 26, 2009

(54) High Power Ultra-Linear TDD Switch

(75) Inventor: Zhangping Yang, Fremont, CA (US)

Correspondence Address: Venture Pacific Law, PC, 5201 Great America Parkway, Suite 270, Santa Clara, CA, 95054, US

(73) Assignee: APACEWAVE TECHNOLOGIES CORPORATION, Fremont, CA (US)

(21) Appl. No.: 12/124,954

(22) Filed: May 21, 2008

(51) Int. Cl. H01Q 3/24

(52) U.S. Cl. 343/876

(57) ABSTRACT

The present invention relates to wide-band high output power ultra-linear TDD switch systems for receiving and/or transmitting signals that can meet wireless communication and base systems requirements. They comprise of an antenna; one or more circulators; and one or more signal ports where at least one of the circulators enables a selectable path for a signal between the antenna and one of said signal ports. This selectable path may be uni-directional. For antenna switches that receive and transmit signals, these switches may have two signal ports, one for transmitting signals and another for receiving signals where at least one of the circulators enables a selectable uni-directional path for a signal between the antenna and a signal port; and at least one of the circulators enables a selectable uni-directional second path for a signal between the antenna and a second signal port. These antenna switches are ultra-linear, have simple base station mechanical structure that can be connected simply with transceivers, capable of handling high power transmissions in TDD wireless communication base station systems, and can have increased receiver sensitivity and increased isolation between the transmitted and received signals.

### FIELD OF INVENTION

The present invention relates to switching circuits and, in particular, it relates to switching circuits for connecting transmitter and/or receivers to antennas.

### BACKGROUND

The acceleration in the expansion of telecommunication networks worldwide has prompted the development of numerous wireless communications systems. Examples of these systems include paging systems, trunk group communication systems, cordless telecommunication systems, and cellular mobile communication systems. However, many existing systems are inadequate to meet the requirements for personal communications. Currently, research efforts in wireless communications are focusing on increasing the system subscriber capacity and spectrum utilization rate, and, reducing the cost of wireless systems. A good wireless system should be portable and capable of providing a variety of communication functions such as voice communication, paging, message transmission, group dispatch communication, locating position, and, data communication. Engineers wrestling with ways to find some new methods for implementing communication systems to meet these criteria are finding that Wide-band Multi-carrier RF and Time Division Duplex (TDD) are the key technologies that provide the following advantages: capability of forming Digital Beam Forming (DBF) based on the smart antenna array that can reduce multi-path fading, raise coverage range, locate position, and reduce the subscriber terminal transmit power; lower cost on RF components and simpler RF circuit structure; ease in locating the positions of the subscriber terminals; and a higher spectrum utilization rate.

The development of wireless communications and microelectronics technology enables the fabrication of multi-carrier RF transceivers with down-converters, up-converters and A/D and D/A converters that reduce the complexity and cost of TDD communication systems. For example, when compared with the traditional base stations, eight-carriers base stations can reduce the complexity of base stations by 60 percent and reduce the size and cost of production by 50 to 60 percent. These advantages ensure that wide-band multi-carrier RF and TDD technology will be used widely in the future.

Antenna switches that can be used with wideband transceivers and that allow multi-carrier RF pass-through simultaneously have to have sufficient linearity for the transmitter's inter-modulator (IM3) to be less than some pre-determined value. FIG. 1a is a typical conventional antenna switch that can be used with transceivers. It comprises of an antenna system that is connected to a single-pole, double-throw electronic switch (123). The antenna system usually comprises of an antenna (113) that is connected to a band pass filter (112) at a terminal of the band pass filter. The other terminal of the band pass filter is connected to the port of the double throw port of the double throw electronic switch (port 1). The other two ports of the switch, a transmit signal port and a receive signal port, are signal ports for the TDD switch that can be used to connect to the transmit output signal port and the receive input signal port of a transceiver.

FIG. 1b is an example of a typical transceiver that may be used with the TDD switch of FIG. 1a. The input transmit signal port that is connected to the DSP (127) is also connected to a transmission system for the transceiver that comprises of a transmit signal processor (128) that is connected in series to a modulator (129), a transmitter (130), a power amplifier (PA) (131), and an output transmit signal port (136). The input receive signal port (137) is connected to a receiver system that comprises of a receiver (124) that is connected in series with a demodulator (125), a receiver signal processor (126), and the output receive signal port that is connected to the DSP. The transmit signal processor and the receive signal processor are connected by a DSP that may be a general baseband processor. The output transmit signal port may be connected to the transmit signal port of an antenna switch while the input receive signal port may be connected to the receive signal port of an antenna switch. However, devices with these conventional antenna switches do not have output RF power of +40 dBm at IM3<=−60 dBc. Therefore, the development of wideband TDD wireless communications systems using these TDD switches is limited.

Moreover, current antenna switches do not separate higher power from lower power transmission and receiving. This limits the amount of the isolation that can be affected between transmitting and receiving, increases the isolation loss, and increases the complexity of the base stations.

Due to the limitations of the prior art, it is therefore desirable to have novel transceiver antenna switches that can be used in high transmitting power TDD wireless communication base system such as the P-CDMA base station whose antenna port output power is larger than 8 Watts when the third inter-modulator is less than −60 dBc.

### SUMMARY OF INVENTION

An object of this invention is to provide antenna switches for transceivers that are ultra-linear and are capable of handling high power transmissions in TDD wireless communication base station systems.

Another object of this invention is to provide antenna switches that are independent units that can be placed in base stations.

Another object of this invention is to provide a multi-stage transceiver antenna switch with one or more front stages having simple designs that can operate at low output power with single input and output.

Another object of this invention is to provide transceiver antenna switches that have a simple base station mechanical structure and can be connected simply with transceivers.

Another object of this invention is to have antenna switches with increased receiver sensitivity and increased isolation between the transmitted and received signals.

The present invention relates to wide-band high output power ultra-linear TDD switch systems for receiving and/or transmitting signals that can meet wireless communication and base systems requirements. They comprise of an antenna; one or more circulators; and one or more signal ports where at least one of the circulators enables a selectable path for a signal between the antenna and one of said signal ports. This selectable path may be uni-directional. For antenna switches that receive and transmit signals, these switches may have two signal ports, one for transmitting signals and another for receiving signals where at least one of the circulators enables a selectable uni-directional path for a signal between the antenna and a signal port; and at least one of the circulators enables a selectable uni-directional second path for a signal between the antenna and a second signal port.

An advantage of this invention is that the antenna switches that are embodiments of this invention are ultra-linear and are capable of handling high power transmissions in TDD wireless communication base station systems.

Another advantage of this invention is that the antenna switches that are embodiments of this invention can be placed in base stations such that power can be supplied to these switches.

Another advantage of this invention is that the antenna switches that are embodiments of this invention have multiple stages where the front stages have simple designs and can operate at low output power with single inputs and outputs.

Another advantage of this invention is that the antenna switches that are embodiments of this invention have simple base station mechanical structure and can be connected simply with transceivers.

Another advantage of this invention is that the antenna switches that are embodiments of this invention have increased receiver sensitivity and increased isolation between the transmitted and received signals.

### DESCRIPTION OF DRAWINGS

The foregoing and other objects, aspects and advantages of the invention will be better understood from the following detailed description of preferred embodiments of this invention when taken in conjunction with the accompanying drawings in which:

FIG. 1a is an example of a prior art antenna switch for transceivers.

FIG. 1b is an example of a transceiver that can be used with antenna switches.

FIG. 2a is an antenna switch that is an embodiment of this invention.

FIG. 2b illustrates the transmit path and the reflected power path for a transmit signal in an antenna switch that is an embodiment of this invention.

FIG. 2c illustrates the receive path and the reflected power path for a receive signal in an antenna switch that is an embodiment of this invention.

FIG. 3 is an antenna switch that is another embodiment of this invention.

FIG. 4a is an antenna switch that is another embodiment of this invention.

FIG. 4b illustrates the transmit path and the reflected power path for a transmit signal in an antenna switch that is an embodiment of this invention.

FIG. 4c illustrates the receive path and the reflected power path for a receive signal in an antenna switch that is an embodiment of this invention.

FIG. 5 is a diagram that illustrates a method for calculating the cascading noise for antenna switches that are embodiments of this invention.

FIG. 6 is an antenna switch that is another embodiment of this invention.

FIG. 7 is an antenna switch that is another embodiment of this invention.

In the figures described above, the same device or elements may be labeled with the same number in the different figures

### DETAILED DESCRIPTION OF THE PREFERRED EMBODIMENTS

In describing the preferred embodiments herein, a signal port is referred herein as a port or terminal in an embodiment that can receive or output a signal from a source such as a transceiver. Thus a transmit signal port may be a port in an embodiment that can receive a transmitted signal from an outside source such as a transceiver while a receive signal port may be a port in said embodiment that can output a signal to an outside source such as a transceiver.

In describing an embodiment herein, the path or pathway for a signal is referred herein as that path that the signal may travel between the antenna of said embodiment and a signal port of this embodiment. Thus, a transmit path in an embodiment may be the path that a transmitted signal travels from the transmit signal port of an embodiment to the antenna while a receive path in an embodiment may be the path that a received signal travels from the antenna to the receive signal port of the embodiment.

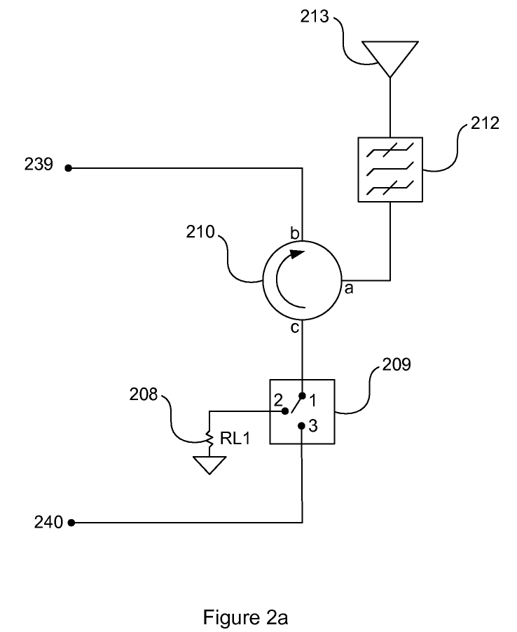

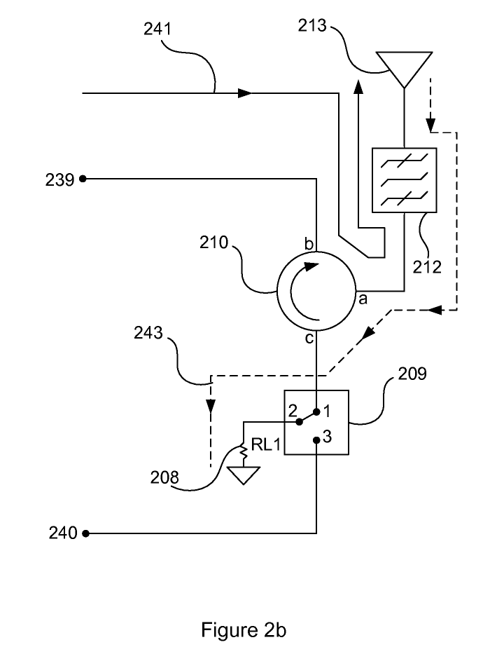

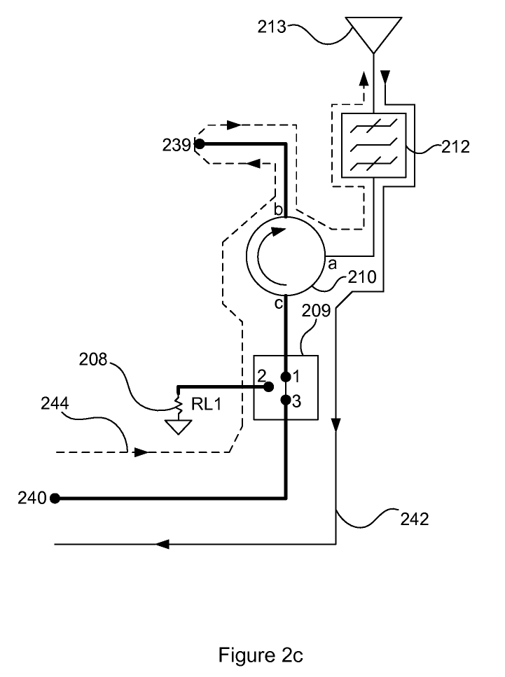

The circulators that are discussed herein or that are used in the embodiments of this invention are generally uni-directional devices that may have a three-port transfer network which allows signal transfer in and along one direction and resists signal transfer in the opposite direction, also referred to as the anti-direction. These circulators can have three ports or terminals, referred herein as terminal a, b, and c. The circulators that are discussed herein are examples of circulators that can allow signal transfer in a preset direction such as the clockwise direction. The direction of signal transfer in the attached figures is indicated by the directional arrow in the circulator symbol. For example, the circulator (210) in FIG. 2a allows signals to travel from terminal b to terminal a, terminal a to terminal c, and terminal c to terminal b with only a small insertion loss. This insertion loss maybe about 0.7 dB. The insertion loss is a lot larger for signals traveling in the opposite direction, from terminal b to terminal c, terminal c to terminal a, and terminal a to terminal b and may be between 30 and 40 dB. Circulators that allow signal transport in the counterclockwise direction can be used similarly. In describing the circulators herein, these circulators are capable of enabling or allowing a path for signals that are uni-directional.

The following embodiments further describe this invention:

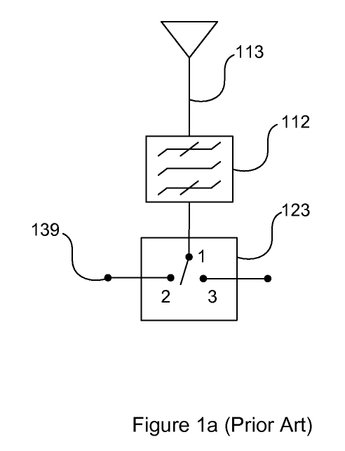

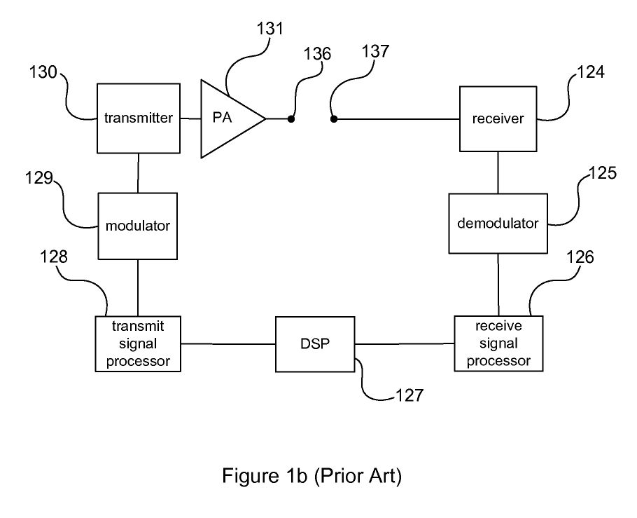

FIG. 2a is an embodiment of this invention of an antenna switch that may be used with transceivers such as the transceiver that is illustrated in FIG. 1b. It has two signal ports, a transmit signal port (239) that may be connected to the output transmit signal port of a transceiver by a transmission cable (233) and a receive signal port (240) that may be connected to the input receive signal port of a transceiver with a reception cable (234).

This antenna switch has an antenna system that comprise of an antenna (213) that can receive or transmit signals. In preferred embodiments, this antenna system may also have a band pass filter (212) that is connected to the antenna and that can attenuate unnecessary radio waves from the transmitting or receiving band in TDD mode where the transmitting frequency maybe the same as the receiving frequency. The band pass filter may be connected to terminal a, one of the terminals of a circulator (210) that is acting as an isolator. Terminal b of the circulator is or may be connected to the transmit signal port (239) while terminal c of the circulator maybe connected to a terminal in a three-port switch (209). This switch may be an electronic switch. When port 1 and port 3 of the switch is connected, the circulator is connected to the receive signal port (240). When the switch in the other position, i.e., when port 1 and port 2 of the switch are connected, the circulator is connected to a resistor or impedance RL1 (208).

The circulator in FIG. 2a acts as an isolator and enables two paths for signals, a transmit path and a receive path such that the transmitted signals travel along the transmit path and the received signals travels along a received signal path. In an antenna switch that is connected to the transceiver such as that shown in FIG. 1b, in the transmit mode, a base-band transmitting signal traveling through a transceiver system such as that illustrated in FIG. 1b travels through the transmitting signal processor (128), modulator (129), transmitter (130), and is amplified to a high power level by the power amplifier PA (131). It then travels to the output transmit signal port of the transceiver and then to the transmit signal port (239) of the switch, possibly along a transmission cable. From there, it travels to terminal b and then to terminal a of the circulator (210), passes through the band pass filter (212), couples to the antenna (213) and then is emitted into space from the antenna. The transmit signal path in this embodiment, the path a transmitted signal travels in this embodiment is indicated by the solid directional line (241) in FIG. 2b.

In the receive mode, port 1 of the electronic switch (209) is connected to port 3. An incoming signal travels from the antenna (213) to the band pass filter (212) to terminal a of the circulator (210). It them travels from terminal a to terminal c of the circulator (210), then through the switch (209) to the receive signal port (240). From the receive signal port, it travels to the transceiver, possibly through a reception cable. If the transceiver used with this embodiment is the one shown in FIG. 1b, then the incoming signal travels to the receiver (124), then to the demodulator (125) and the received signal processor (126). The receive path (242) in this embodiment, the path that a received signal travels in this embodiment is indicated by a solid directional line as illustrated in FIG. 2c.

The uni-directional character of the circulator can reduce the impact of any reflection of RF power. This reflection may occur due to antenna impedance mismatch or impedance mismatch of the devices in the transceiver or the antenna switches. For example, if the antenna system or the antenna (213) and band pass filter (212) is not properly matched to terminal a of circulator (210) due to antenna or filter match errors or environmental condition variations, a signal traveling to the antenna such as a transmitted signal may be partially reflected resulting in reflected power. This reflected power would travel from the antenna system (213) and (212) to terminal a of the circulator (210). Since the circulator is unidirectional, this reflected power transfers only to terminal c that is coupled to port 1 of the switch (209). In the transmission mode, port 1 of this switch is connected to port 2 where the reflected power can then be absorbed by the load impedance RL1 (208). The path of this reflected power (243) is indicated by the dotted directional line in FIG. 2b. The path of this reflected power is isolated from the transmit path as the reflected power cannot be transferred to terminal b of the circulator that is acting as a single direction isolator.

In the receive mode, if the transceiver used with this embodiment is the transceiver illustrated in FIGS. 1b and 1f the impedance of a device in the transceiver such as the receiver (124) is not properly matched to a receiver cable, a part of the incoming signal maybe reflected by the device through the switch (209), terminal c through terminal b of the circulator (210) to the output of a device in the transmission system of the transceiver such as the PA (131). In the receive mode, the PA (131) is usually powered down such that its output impedance does not match the impedance of the transmission cable. Therefore, the device in the transmission system such as the PA (131) may again reflect the reflected incoming signal back through to the circulator (210), the band pass filter (213) to the antenna (212). If the antenna (213) also has impedance mismatching, some of the reflected incoming signal power may yet again be reflected in the same manner as previously described. The path for these reflected signals (244) is indicated by the dotted directional line in FIG. 2c.

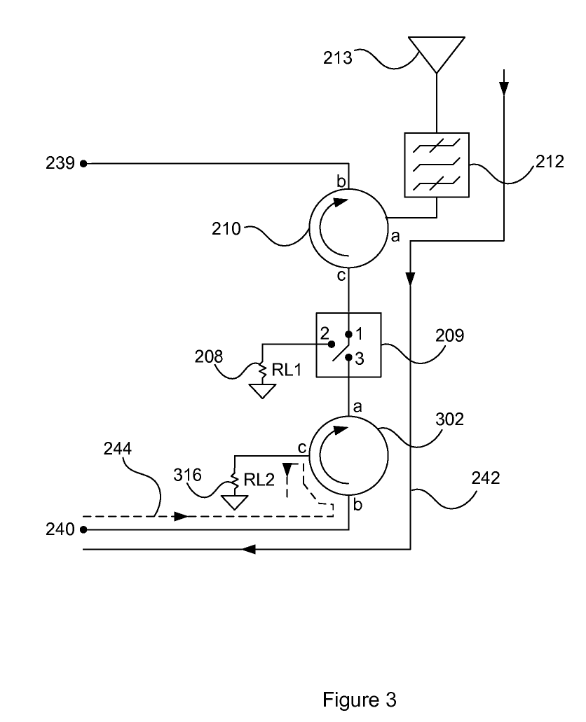

In another embodiment that is illustrated in FIG. 3, to prevent this phenomenon of multiple reflections, an isolator that is a signal-separating element may be inserted between the switch (209) and the receive signal port (240). This isolator may be a three-terminal circulator (302) where one of the terminals of this second circulator may be terminated by a second impedance or resistance RL2 (316). As illustrated in FIG. 3, the incoming receive signal that is reflected from the transceiver travels to terminal b of this second circulator (302), then to terminal c of the second circulator (302), and is absorbed by the this second resistance RL2 (316). The receive path (342) is indicated by the solid directional line while the reflected path (344) in this mode is indicated by the dotted directional line in FIG. 3. When compared with the device illustrated in FIG. 2a, the receive path (342) may have a larger insertion loss that can be about 0.7 dB. The insertion of this second circulator may also result in decreased sensitivity for the receiver in a transceiver system of about 0.7 dB.

If the antenna switch circuit illustrated in FIG. 3 is used with a transceiver system that is similar to that illustrated in FIG. 1b, 1f the insertion loss of the band pass filter (212) is about 1.3 dB, the switch (209) is about 0.7 dB, and the circulators (210) and (302) are about 0.7 dB, the insertion loss of the transmit path maybe about 2.0 dB and the receive path about 3.4 dB. If the output power for the transceiver such as the output power for the power amplifier is 10 Watts (40 dBm), as a result of the transmit path insertion loss, the antenna terminal output power maybe only 6.3 Watts. For this example, the circulator (210) and band pass filter (212) consume 37 percent power of output power. If an antenna output port power requires 10 Watts of power, the output power of the transceiver will have to be 15.8 Watts. This large power requirement may increase the difficulty of designing an adequate transceiver, especially a multi-carrier ultra-linear transceiver such as those with IM3 less than −60 dBc where the efficiency of the power amplifier maybe only 5 to 10 percent. Therefore, the above embodiment may not be suitable for applications that require a large power output, regardless of the size of the power supply or the isolation between transmit and receive paths.

The receiver sensitivity for this embodiment may also be limited. For example, when the insertion loss in the receive path is 3.4 dB, the receive sensitivity of the transceiver and the antenna switch may be decreased by 3.4 dB.

This embodiment requires two cables to connect the antenna switch to the output transmit signal port of the transceiver with terminal b of the first circulator (210) and the input receive signal port with terminal b of the second circulator (302). This results in a more complex mechanical structure for the base station.

In order to improve on the two embodiments described above, antenna switches that are preferred embodiments maybe divided into two stages, the front stage and the antenna switch stage. These two stages may be connected by a single cable. The front stage may operate at low output power, e.g., for power between 0 to 10 dBm while the antenna switch stage may operate at a much higher power. This will allow a device to easily choose the proper desired power and lower the cost of the antenna switches.

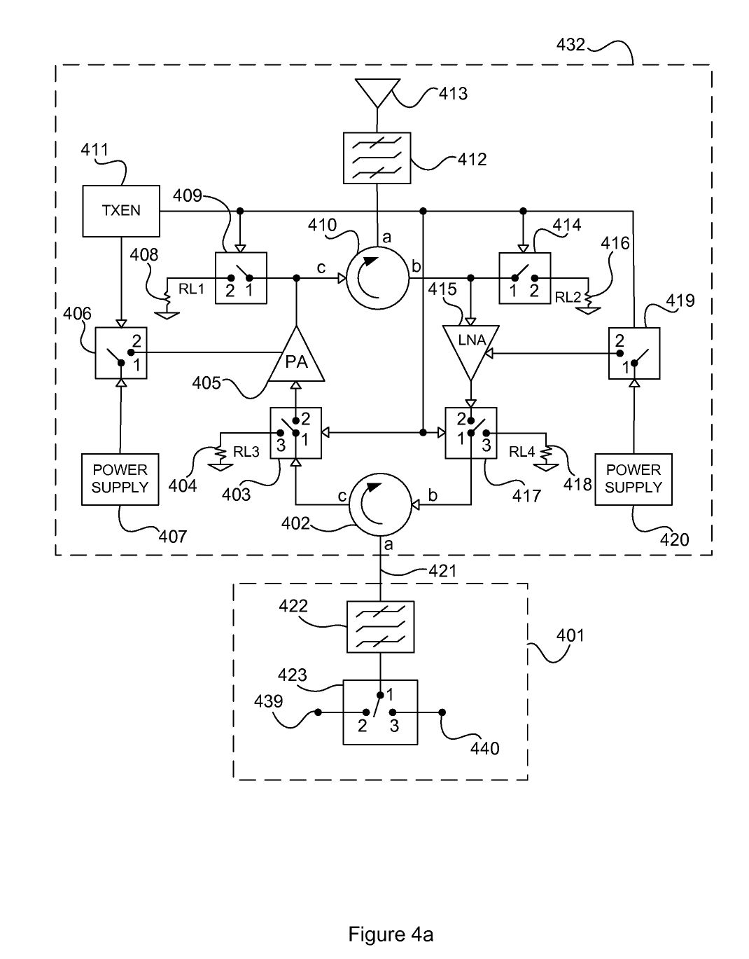

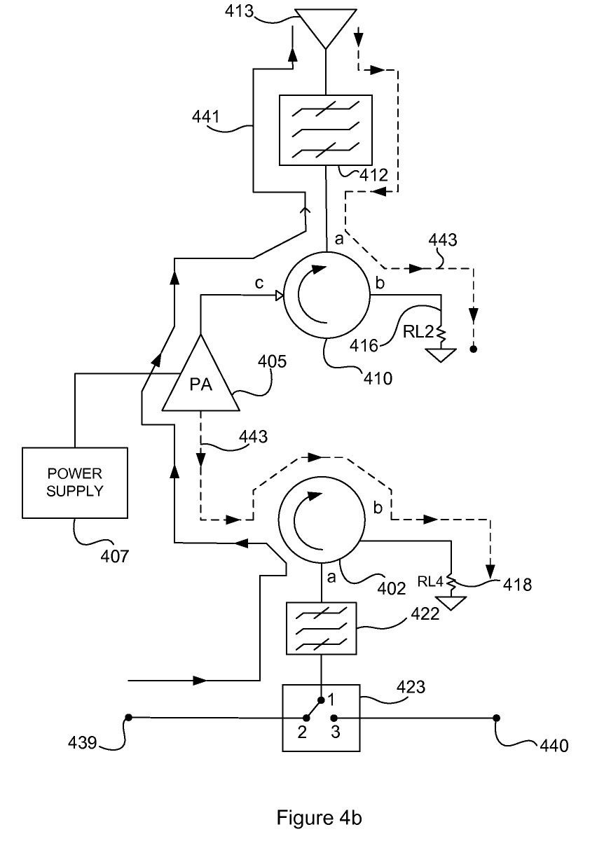

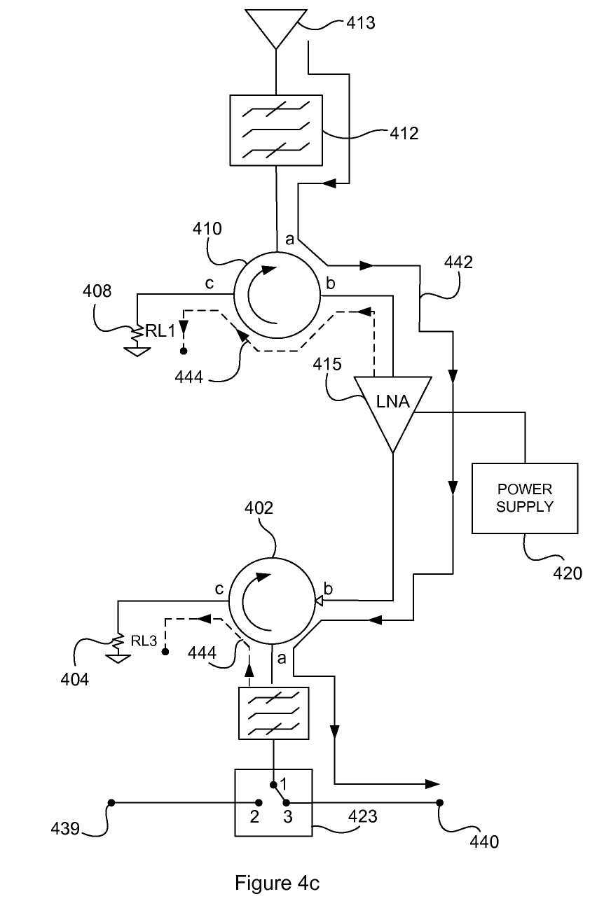

FIG. 4a illustrates such a preferred embodiment of an antenna switch where the front stage (401) and the antenna switch stage (432) are connected by a single cable (421).

The front stage (401) of the embodiment illustrated in FIG. 4a includes a TDD switch (423) that may also be referred to as a transmitting/receiving duplexer and a common band pass filter (422) for transmitting or receiving. Port 1 of this TDD switch is connected to the common band pass switch and this port switches between port 2 and port 3 of the same switch. Port 2 of the switch is the transmit signal port (439) or may be connected to the transmit signal port that may be connected to the output transmit signal port of a transceiver or a transmitter while port 3 of the switch may be the receive signal port (440) or connected to the receive signal port (440) that may be connected to the input receive signal port of a transceiver or a receiver.

This embodiment may be used with typical TDD transceivers with small output power such as those in PHS and CT2 base stations. An example of a transceiver that can be used with this embodiment is the transceiver illustrated in FIG. 1b.

When lower power such as lower RF power is needed in operation, the antenna switch stage (432) portion of this antenna switch may be removed or disconnected and the band pass filter (422) front stage may be connected directly to an antenna.

For this preferred embodiment, a controller (TXEN) (411) is used to control the switches (409), (406), (403), (414), (419), and (417) in the antenna switch stage (432) to increase isolation between the receive path and the transmit path, and to prevent the receive signals from affecting the transmit path and vice versa. If one or more amplifiers are used in this antenna switch stage, the TXEN (411) may also control the supply of power to one or more of these amplifiers. The controller TXEN (411) controls switch (406) that connects a power supply (407) to a power amplifier, PA (405) and switch (419) that connects a power supply (420) to another power amplifier, preferably a low noise amplifier (LNA) (415). A power amplifier is enabled, when it is connected to its power supply or when it is in a signal path. Likewise, a power amplifier is disabled when it is not connected to its power supply or when it is not in a signal path. The TXEN (411) also controls and synchronizes signals from front stage (401).

The antenna switch stage (432) of the preferred embodiment illustrated in FIG. 4a may have two circulators, circulator (410) and circulator (402) that can act as duplexers for the transmit and receive signals.

To operate at higher power, one or more amplifiers may be used in the antenna switch stage. For example, in the preferred embodiment illustrated in FIG. 4a, an amplifier PA (405) that is powered by a power supply (407) is added to the transmit path and used to amplify transmit signals while a low noise power amplifier LNA (415) that is powered by another power supply (420) is added to the receive path and used to amplify the transmit signals. Switch (406) and switch (419) in FIG. 4a may be used to connect the PA (405) and the LNA (415) to their respective power supplies (407) and (419) by connecting port 1 and port 2 of the switches. These switches may be DC electronic switches such as the Harris Model RFIK49157. When switch (406) is connected, power is supplied to the PA (405) and the power amplifier is enabled. Similarly, when switch (419) is connected, power is supplied to the LNA (415) and this low noise amplifier is enabled.

The antenna (413) in this antenna switch stage is connected to a port of the RF band pass filter (412) while the other port of the band pass filter maybe connected to terminal a of a circulator (410). Terminal b of circulator (410) is connected to the input of a power amplifier, preferably a power amplifier such as a LNA (415) and port 1 of switch (414). Terminal c of circulator (410) is connected to the output of a power amplifier (PA) (405) and port 1 of switch (409). These switches are also controlled by the controller TXEN (11). Because of the uni-directional nature of the circulator, a transmit signal from the transmit signal port of this antenna switch on its way to the antenna enters terminal c of this circulator and can only travel in the clockwise direction to terminal a. It cannot travel from terminal c to terminal b. Therefore, this circulator selects and enables the uni-directional transmit signal path that a transmit signal travels. Similarly, a receive signal from the antenna on its way to the receive signal output of this antenna switch stage enters terminal a of the circulator and can only travel to terminal b. Therefore, it selects and enables the uni-directional receive signal path that a receive signal travels.

Terminal a of circulator (402) may be connected to the front stage via the pass through cable (421). For example, it may be connected to the RF band pass filter (422) in the front stage via the pass through cable (421). Terminal b of circulator (402) maybe connected to port 1 of switch (417). Terminal c of circulator (402) is connected to port 1 of switch (403). Because of the uni-directional nature of the circulator, a transmit signal from the transmit signal port of this antenna switch on its way to the antenna enters terminal a of this circulator and can only travel in the clockwise direction to terminal c. It cannot travel from terminal a to terminal b. Therefore, this circulator selects and enables the uni-directional transmit signal path that a transmit signal travels. Similarly, a receive signal from the antenna on its way to the receive signal port of this antenna switch stage enters terminal b of the circulator and can only travel to terminal a. Therefore, it selects and enables the uni-directional receive signal path that a receive signal travels.

In addition, in order to minimize the reflected power for the transmit and receive signals, matching resistances or impedances, RL1 (408), RL2 (416), RL3 (404), and RL4 (418), that are controlled by the switches (409), (414), (403), and (417) are added. In some preferred embodiments, RL1=(RL/TX)//Ro where RL/TX is the countervailing impedance and Ro is the output impedance of the power amplifier PA (405), RL2=(RL/RX)//Ri where RL/RX is the countervailing impedance and Ri is the input impedance of the LNA (415), and RL3 and RL4 may be set equal to 50 ohms. When the switch controlling one of these resistance is positioned such that the resistance is electrically connected, that resistance is referred to as being enabled. Likewise, when the switch controlling these resistance or impedance is positioned such that the impedance is not electrically connected, that resistance is referred to as being disabled.

Switch (403) and switch (417) are switches that are controlled by the controller TXEN. They maybe a RF SPDT (Single-Pole, Double-Throw) electronic switch. The Stanford Microdevices Model SSW-224 is an example of a switch that can be used to switch between ports 2 and 3 from port 1 of these switches.

Switch (403) switches between two positions. When port 1 of this switch is connected to its port 2, it forms a part of the transmit path for the transmitted signals by connecting terminal c of the circulator (402) to the PA (405) of this switch stage antenna. When port 1 is connected to port 3 of switch (403), it enables RL3 by connecting the matching load RL3 (404) to terminal c of circulator (2).

Similarly, switch (417) switches between two positions. When port 1 of this switch is connected to its port 2, it forms a part of the receive path for received signals by connecting terminal b of the circulator to the LNA (15). When port 1 is connected to port 3, it enables RL4 by connecting the matching load RL4 (418) to terminal b of circulator (402).

Switch (409) and switch (414) are switches that are controlled by the controller TXEN and may be a RF SPST (Single-Pole, Single-Throw). The Stanford Microdevices Model SSW-524 is an example of a switch that can be used to connect port 1 to port 2 of each of the switches. Switch (409) switches the load RL1 (408), a countervailing impedance. When receiving signals, switch (406) is in the off position and power is not supplied to the PA (405), RL1 (408) is enabled and connected to terminal c of the circulator (410). RL1 and the output impedance of the PA (405) may form a matching impedance for terminal c of circulator (410) such that any reflective power from the receive signal traveling from terminal c of circulator (410) may be absorbed by these impedances. Therefore, in preferred embodiments, RL1=(RL/TX)//Ro where RL/TX is the countervailing impedance, and Ro is the output impedance of the power amplifier PA (405).

Similarly, switch (414) switches the load RL2 (416), a countervailing impedance. During transmission when power is not supplied to the low noise amplifier (LNA) (415) and switch (419) is set in the off position, RL2 (416) is enabled and connected to terminal b of circulator (410). RL2 and the input impedance of LNA (415) form matching impedance for terminal b of circulator (410) such that any reflective power from the transmit signal traveling from terminal b of the circulator may be absorbed by this impedance. Therefore, in preferred embodiments, RL2=(RL/RX)//Ri where RL/RX is the countervailing impedance and Ri is the input impedance of the LNA (415).

The RF band pass filter (412) may be the common filter for both the transmitting and receiving signals that may attenuate unnecessary radio waves from the transmitting or receiving band.

During the transmit mode, when TXEN (411) is set at a mode such as mode “1”, the following are the settings for the switches and circulators:

Switch 423: port 1 is connected to port 2 such that the transmit signal port is connected to the antenna;
Switch (403): port 1 is connected to port 2. There is a transmit path for transmitting signals. The resistance RL3 (404) is not connected and not enabled;
Switch (406): port 1 is connected to port 2. This switch is in the on position and power is being supplied to the PA (405) for the transmitting signals;
Switch (414): port 1 is connected to port 2. The switch is in the on position and RL2 (416) is enabled and connected to terminal b of circulator (410). RL2, together with the input impedance of the LNA (415) may form a matching impedance for circulator (410);
Switch (417): port 1 is connected to port 3. The receive path for receiving signals is disconnected and the resistance RL4 (418) that can be, for example, a 500 ohm load is enabled and connected to terminal b of circulator (402). RL4 may be the matching resistance for terminal b of circulator (402);
Switch (409): port 1 is not connected to port 2. The switch is in the off position and the matching resistance RL1 (408) is not enabled. In the preferred embodiments, the output impedance of the PA (405) may be set to equal the impedance of terminal c of circulator (410); and
Switch (419): port 1 is not connected to port 2. This switch is in the off position. The power supply for LNA (415) is disconnected. This may increase the isolation between the transmit path and the receive path.

With this configuration, a transmit signal traveling from the front stage transceiver (401) passes from terminal a to terminal c of circulator (402). It is then amplified by the PA (405). The amplified transmit signal then passes from terminal c to terminal a of circulator (410), through the band pass filter (412) to the common antenna for both transmit and receive signals (413), and is emitted into space from the antenna. In one preferred embodiment, the insertion loss of the circulator may be about 0.7 dB, the gain of the PA (5), and the power amplifier may be between 30 to 50 dB such that the output power of the PA (5) is from 30 to 40 dBm at IM3 less than −60 dBc. The transmit path, i.e., the path formed by the transmit signal, in the antenna switch stage is illustrated in FIG. 4b as the solid directional line (441).

The characteristics of the antenna are affected by its surrounding environment and mismatching at the antenna can occur frequently. If mismatching occurs, part of the transmitted signal can be reflected at a port of the antenna. This reflected signal then passes through the band pass filter (412) to return to terminal a of circulator (410). Since the circulator is uni-directional, the reflected signal passes from terminal a to terminal b of the circulator where it may be absorbed by the matching impedance RL2 (416). The input impedance of the LNA (415) may resist the return of the reflected power to the output of the PA (5). Similarly, if mismatching occurs at the input port of the PA (405), a part of the power of the outgoing transmitting signal is reflected from the input port and returns to terminal c of circulator (402). It then travels via circulator (402) clockwise to terminal b and is then absorbed by the impedance or resistance RL4 (418). The paths for these reflected signals are illustrated by the dotted directional lines (443) in FIG. 4b.

During the receive mode, when the TXEN (411) is set at a mode such as mode “0”, the following are the settings for the switches:

Switch 423: port 1 is connected to port 3 such that the receive signal port is connected to the antenna;
Switch (417): port 1 is connected to port 2. This forms a receive path for received signals. The resistance RL4 (418) is not connected and not enabled;
Switch (419): port 1 is connected to port 2 such that the switch is in the on position and power is supplied to the LNA (415) from the power supply (420);
Switch (403): port 1 is connected to port 3. The transmit path for transmitting signals is disconnected and the resistance RL3 (404) that can be, for example, a 500 ohm load is enabled and connected to terminal c of circulator (402). RL3 may be a matching impedance for terminal c of circulator (402);
Switch (409): port 1 is connected from port 2. This switch is in the on position and the resistance RL1 (408) is enabled to prevent receiver pass circuit mismatching. RL1, together with the output impedance of the PA (405), may form a matching impedance for terminal c of the circulator (10);
Switch (414): port 1 is not connected to port 2. This switch is in the off position. The resistance RL2 (416) is not enabled and not connected. In preferred embodiments, the input impedance of the LNA (415) may be set to equal the impedance of terminal b of circulator (410); and

Switch (406): port 1 is not connected to port 2. This switch is in the off position. The PA (405) is powered down and no power is supplied to the PA from the power supply (407). This may maximize isolation between the transmit path and the receive path, reduce background noise for the receive signals, and minimize input noise level for the LNA such that the receive signals are not blocked.

A receive signal from the antenna passes to the band pass filter (412), then from terminal a to terminal b of circulator (410), to the LNA (415), through switch (417), terminal b to terminal a of circulator (402) to the band pass filter (422) and switch (423) in the front stage. This receive path (442) for the antenna switch stage for receiving signals is indicated by the dotted directional line in FIG. 4c.

When mismatch occurs at the input port of the LNA (415), a part of the power of the incoming receive signal is reflected from the input port and returns to terminal b of circulator (410). It then travels via circulator (410) clockwise to terminal c and is then absorbed by the impedance or resistance RL1 (408). Similarly, if mismatching occurs between the front stage and the antenna switch stage, e.g., at the upper port of the band pass filter (422), the reflected signal from the incoming receiving signal from antenna (413) may be absorbed by resistance or impedance RL3 (404). The path for this reflected signal (444) is illustrated by the dotted directional line in FIG. 4b.

The antenna switch of this preferred embodiment shown in FIG. 4a allows for a transmit signal path and a receive signal path that may be isolated. These paths are illustrated by solid directional lines in FIGS. 4b and 4c respectively.

While the preferred embodiment illustrated by FIG. 4a can be used with a transceiver, it can also be used with either a transmitter or a receiver. The antenna switch stage of this preferred embodiment that can be used with a transmitter may be simplified to that illustrated in FIG. 4b. Similarly, the antenna switch stage of this preferred embodiment that may be used with a receiver may be simplified to that illustrated in FIG. 4c.

Receiver sensitivity is critical for the propagation of received signals. Conventional antenna switches can reduce receiver sensitivity by as much as 3.4 dB. Cascaded noise figure calculations for preferred embodiments such as that illustrated in FIG. 4a can be compared with that of other embodiments such as that illustrated in FIG. 3.

For applications such as for multi-carrier inter-modulation, the SPDT electronic switch (403) and electronic switch (418), PA (405), circulator (410), LNA (415), and band pass filter (412) in the antenna switch stage of the circuit in FIG. 4a may be selected to be ultra-linear.

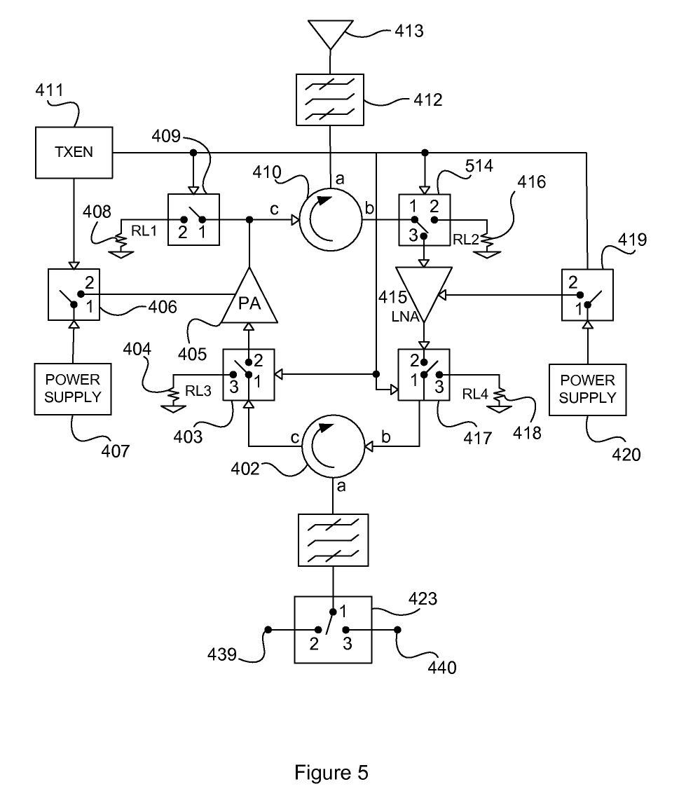

A modification of the preferred embodiment illustrated in FIG. 4a provides another preferred embodiment whose antenna switch stage is illustrated in FIG. 5. The front stage of this preferred embodiment may be the same as the front stage of the preferred embodiment illustrated in FIG. 4a. The antenna switch stage of this embodiment is the same as that in FIG. 4a except, instead of the two port switch (414) in FIG. 4a, switch (514) is a three port switch that allows the switching between port 2 and port 3 from port 1. Port 1 and port 3 of switch (514) allow a connection between terminal b of the circulator (410) with the LNA (415) while port 1 and port 2 allow the connection between terminal b of circulator (410) and the matching resistance load RL2 (416). During the transmit mode, similar to that in the embodiment illustrated in FIG. 4a, port 1 and port 2 of switch (514) are connected and therefore RL2 is enabled and connected to terminal b of circulator (410). The reflected power reflected by the transmit signal from the antenna (413) can be absorbed by this matching resistance. However, as distinguished from the preferred embodiment illustrated in FIG. 4a, during the transmit mode, switch (514) disconnects the LNA (415) from the terminal b of circulator 10 as port 3 and port 1 are disconnected. This embodiment has advantages as well as disadvantages. It may be easier to obtain impedance matching for terminal b of circulator (410). However, the receiver sensitivity of this preferred embodiment decreases by 0.7 dB when compared with the embodiment illustrated in FIG. 4a.

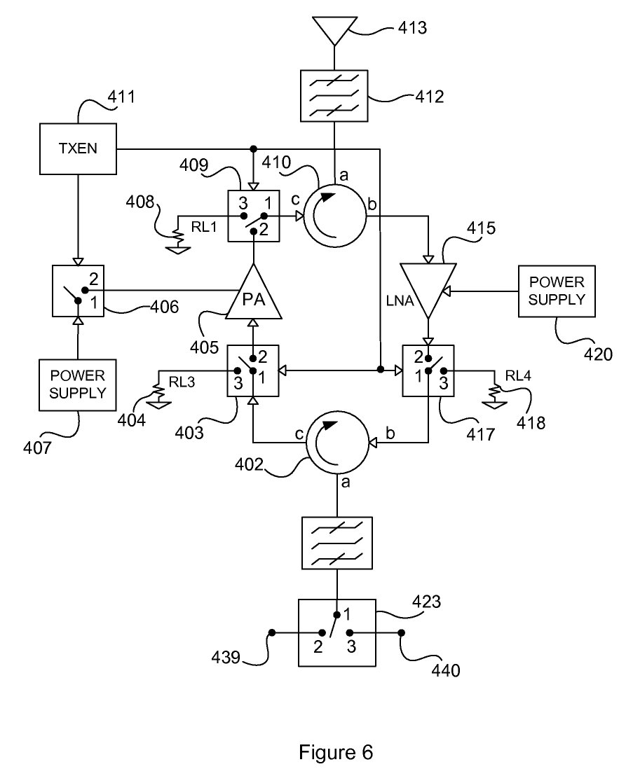

FIG. 6 illustrates the antenna switch stage of another modification of the preferred embodiment illustrated in FIG. 4a where, instead of connecting the LNA (415) to its power supply through a switch (419) that is controlled by the TXEN, the power supply for the LNA (415) is directly connected to its power supply (420) such that there is a constant supply of power to the LNA (415). For this embodiment, it is easy to obtain impedance matching for terminal b and terminal c of circulator (410). However, the LNA (415) may be damaged by reflected power due to antenna mismatch. In addition, the transmit path loss for switch (409) may be increased.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We Claim:

1. An antenna switch for transmitting and receiving one or more signals, comprising:
an antenna;
one or more circulators;
one or more signal ports; and
wherein at least one of said circulators enables a selectable path for a signal between the antenna and one of said signal ports.

2. The antenna switch of claim one wherein at least one of said circulators enables a selectable uni-directional path for a signal between the antenna and one of said signal ports.

3. The antenna switch of claim 2 wherein
said antenna switch having two or more of said signal ports;
at least one of said circulators enables a selectable uni-directional first path for a signal between the antenna and a first signal port; and
at least one of said circulators enables a selectable uni-directional second path for a signal between the antenna and a second signal port.

4. The antenna switch of claim 2 wherein
at least two of said circulators enable a selectable path between the antenna and one of said signal ports.

5. The antenna switch of claim 1 wherein
at least two of said circulators enable a selectable first path for a signal between the antenna and a first signal port; and
at least two of said circulators enable a selectable second path for a signal between the antenna and a second signal port.

6. The antenna switch of claim 5 wherein said selectable first path is uni-directional and said selectable second path is uni-directional.

7. The antenna switch of claim 2 further comprising a power amplifier.

8. The antenna switch of claim 2 further comprising one or more amplifiers that can be enabled or disabled.

9. The antenna switch of claim 3 further comprising a power amplifier.

10. The antenna switch of claim 3 further comprising one or more amplifiers that can be enabled or disabled.

11. The antenna switch of claim 4 further comprising a power amplifier.

12. The antenna switch of claim 4 further comprising a power amplifier that can be enabled or disabled.

13. The antenna switch of claim 8 wherein said enabled power amplifier is in said selectable path between said antenna and said signal port.

14. The antenna switch of claim 2 further comprising one or more impedances that can be enabled or disabled.

15. The antenna switch of claim 3 also comprising one or more impedances that can be enabled or disabled.

16. The antenna switch of claim 5 also comprising one or more impedances; and wherein each of said circulators having three or more terminals;
one terminal of at least one of said circulators is not in said selectable path;
said impedances can be enabled or disabled; and
when one or more said impedances are enabled, at least one of said enabled impedances is connected to said terminal that is not in said selectable pathway.

17. An antenna switch for transmitting and receiving one or more signals having an antenna and comprising a front stage and an antenna switching stage wherein said front stage comprising one or more signal ports; and
said antenna stage comprising one or more circulators wherein at least one circulator enables a selectable uni-directional path for a signal between the antenna and one of said signal ports.

18. The antenna switch of claim 17 wherein said antenna stage further comprising one or more power amplifiers.

19. The antenna switch of claim 18 wherein said one or more of said power amplifiers can be enabled or disabled.

20. The antenna switch of claim 19 wherein said enabled power amplifiers is in said selectable path.

21. The antenna switch of claim 17 wherein said antenna switch also comprising one or more impedances.

22. The antenna switch of claim 21 wherein said antenna switch also comprising one or more impedances and at least one of said impedances can be enabled or disabled.

23. A antenna switch for transmitting and receiving one or more signals, comprising:
an antenna;
a plurality of circulators;
one or more signal ports;
one or more impedances;
one or more power amplifier; and
wherein at least one of said circulators enables a selectable uni-directional path for a signal between the antenna and one of the signal ports;
at least one of said amplifiers can be enabled or disabled; and
at least of said impedances can be enabled or disabled.

24. The antenna switch of claim 23 wherein said antenna switch having two or more of signal ports.
